(19) United States
(12) Patent Application Publication
(10) Pub. No.: US 2009/0131133 A1
(43) Pub. Date: May 21, 2009

(54) Doll catching game set with two game functions

(76) Inventor: Yi-Chiang Yang, Changhwa (TW)

Correspondence Address: CHARLES E. BAXLEY, ESQUIRE, 90 JOHN STREET, SUITE 309, NEW YORK, NY, 10038, US

(21) Appl. No.: 11/985,496

(22) Filed: Nov. 15, 2007

(51) Int. Cl. A63F 13/02; G07F 11/50

(52) U.S. Cl. 463/7; 463/47; 221/12

(57) ABSTRACT

A doll catching game set includes a base and a display portion in which dolls are put and a claw is controlled by the user to catch a doll in the display portion. An electronic roulette is located in the display portion and includes a circuit board which is activated to display a code on the roulette when no doll is caught by the user. A dispensing portion is connected in the display portion and includes a threaded member which is driven by a motor which is activated to rotate the threaded member. A treat is mounted to the threaded member and located in one of pitches of the threaded member. The tread drops from a free end of the threaded member and the user can have the treat.

### FIELD OF THE INVENTION

The present invention relates to a doll catching game set including a claw for catching dolls and an electronic roulette for dispensing a treat if the user cannot catch a doll.

### BACKGROUND OF THE INVENTION

A conventional doll catching game set includes a space for receiving dolls therein and a claw which is controlled by the user and movable across the space so that the user inputs a command to lower the claw and tries to catch a doll which is then released and obtained by the user as the prize. However, the doll catching game set can only provide the single function of catching a doll and the catching requires skills and experience. Most of the users cannot get a doll even tried many times and the users are frustrated by the failures.

The present invention intends to provide a doll catching game set which provides an electronic roulette for the users who cannot get any doll and provides a chance to have a treat.

### SUMMARY OF THE INVENTION

The present invention relates to a doll catching game set which comprises a base and a display portion connected on the base. A claw is controlled by a control portion on the base and movably located in the display portion so as to catch a doll in the display portion. A first retrieving opening and a second retrieving opening are defined in the base. An electronic roulette is located in the display portion and includes a front panel connected to a frame. A circuit board is connected to an inside of the frame. The front panel has a plurality of partitions marked thereon and a plurality of light members are connected to the circuit board and located corresponding to the partitions respectively. A dispensing portion is connected in the display portion and includes a threaded member which is driven by a motor. A rod is located parallel and beneath the threaded member. A treat is mounted to the threaded member and located in one of pitches of the threaded member. The tread is moved toward a free end of the threaded member when the threaded member is rotated and the treat drops into a through hole and obtained by the user from the second retrieving opening.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the doll catching game set of the present invention;

FIG. 2 shows the dispensing portion and the ramp unit of the doll catching game set of the present invention, and

FIG. 3 shows that the electronic roulette of the doll catching game set of the present invention.

### DETAILED DESCRIPTION OF THE PREFERRED EMBODIMENT

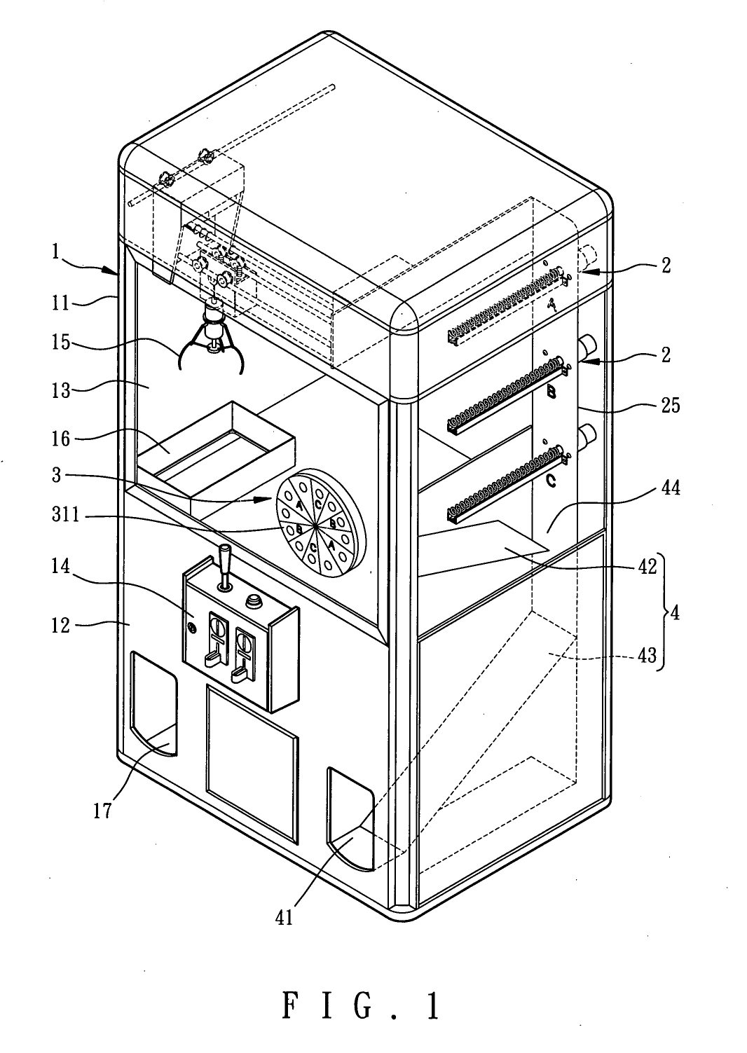

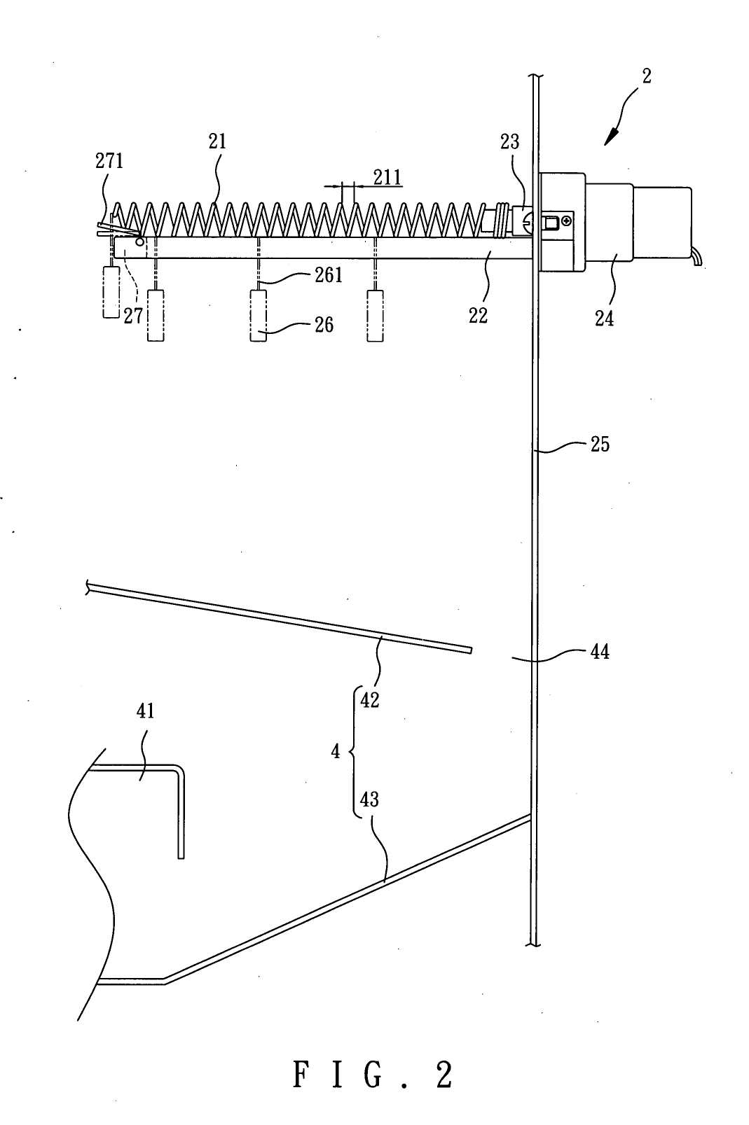

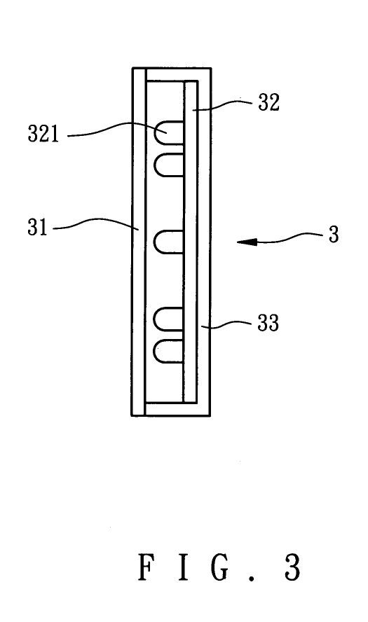

Referring to FIGS. 1 to 3, the doll catching game set 1 of the present invention comprises a base 12 and a display portion 11 is connected on the base 12. The display portion 11 includes a transparent window 13 and a space is defined in the display portion so that dolls (not shown) are received in the display portion 11. A claw 15 is movably located in the display portion 11 and can be controlled by operation of a control portion 14 connected to the base 12 such that the claw 15 moves across the display space and catches a doll. A separation board separates the base 12 and the display portion 11, a through hole 16 is defined through the separation board. A first retrieving opening 17 and a second retrieving opening 41 are defined in the base 12, the through hole 16 communicates with the first retrieving opening 17. When a doll is caught by the claw 15 the doll is released into the through hole 16 and the user can get the doll via the first retrieving opening 17.

A plurality of dispensing portions 2 are connected in the display portion 11 and each dispensing portion 2 includes a threaded member 21 which has one end mounted to a shaft 23 of a motor 24 which rotates the shaft 23 and the threaded member 21. A rod 22 is located parallel and beneath the threaded member 21. A treat 26 is connected to a loop 261 which is mounted to the threaded member 21 and located in one of pitches of the threaded member 21. A free end of the threaded member 21 is located above the through hole 16. A calculation unit 27 is connected to a free end of the rod 22 and includes a checking member 271 which is located corresponding to the free end of the threaded member 21. The treat 26 can be disengaged from free end of the threaded member 21 and touches the checking member 271.

An electronic roulette 3 is located in the display portion 11 and includes a front panel 31 connected to a frame 33, a circuit board 32 is connected to an inside of the frame 33. The front panel 31 includes a plurality of partitions 311 marked thereon and the partitions 311 each include a code marked thereon. The code can be a pattern, a number, an alphabet or any known note. A plurality of light members 321 are connected to the circuit board 32 and located corresponding to the partitions 311 respectively.

A ramp unit 4 is located below the dispensing portions 2 and communicates with the second retrieving opening 41. The ramp unit 4 includes a first ramp 42 and a second ramp 43, a first end of the first ramp 42 is located higher than a second end of the first ramp 42. The free end of the threaded member 21 is located above the first end of the first ramp 42. A drop hole 44 is defined between a sidewall 25 of the base 12 and the second end of the first ramp 42. The second ramp 43 has a first end which is locate higher than a second end of the second ramp 43. The first end of the second ramp 43 is located close to the drop hole 44.

If the user cannot catch a doll by using the claw 15, the electronic roulette 3 is activated and the light members 321 flash in a sequence until the user presses a button to stop the flash-and only one light member 321 is remained “ON” status which shows the specific code is chosen. The specific code can represent “play again” or to activate one of the dispensing portion 2 which dispenses a treat 26 to the user.

The doll catching game set provides another game function which allows the user to have a treat when no doll is caught. The electronic roulette and the dispensing portions 2 do not obstruct the operation of the claw 15.

While we have shown and described the embodiment in accordance with the present invention, it should be clear to those skilled in the art that further embodiments may be made without departing from the scope of the present invention.

What is claimed is:

1. A doll catching game set comprising:
a base and a display portion connected on the base, a space defined in the display portion and a claw movably located in the display portion, a control portion connected to the base so as to control the claw, a separation board separating the base and the display portion, a through hole defined through the separation board, a first retrieving opening and a second retrieving opening defined in the base;
an electronic roulette located in the display portion and including a front panel connected to a frame, a circuit board connected to an inside of the frame, the front panel having a plurality of partitions marked thereon and a plurality of light members connected to the circuit board and located corresponding to the partitions respectively, and
a dispensing portion connected in the display portion and including a threaded member which is driven by a motor, a rod located parallel and beneath the threaded member, a treat mounted to the threaded member and located in one of pitches of the threaded member, a free end of the threaded member located above the through hole.

2. The game set as claimed in claim 1, wherein a calculation unit is connected to a free end of the rod and includes a checking member which is located corresponding to the free end of the threaded member, the treat is disengaged from free end of the threaded member and touches the checking member.

3. The game set as claimed in claim 1, wherein a ramp unit is located below the dispensing portion and communicates with the second retrieving opening, the ramp unit includes a first ramp and a second ramp, a first end of the first ramp is located higher than a second end of the first ramp, the free end of the threaded member is located above the first end of the first ramp, a drop hole defined between a sidewall of the base and the second end of the first ramp, the second ramp has a first end which is locate higher than a second end of the second ramp, the first end of the second ramp is located close to the drop hole.

4. The game set as claimed in claim 1, wherein the partitions of the front panel includes a code marked thereon.
